(19) United States
(12) Patent Application Publication
(10) Pub. No.: US 2026/0303563 A1
(43) Pub. Date: Oct. 1, 2026

(54) DOMAIN NAME SYSTEM FILTERING AT EDGE NETWORK DEVICE

(71) Applicant: Sophos Limited, Abingdon (GB)

(72) Inventors: Dipak Kr Das, Bangalore (IN); Robert Paul Andrews, Pflugerville, TX (US); Yogesh Bansal, Bangalore (IN); Prashil Rakeshkumar Gupta, Ahmedabad (IN)

(21) Appl. No.: 19/352,891

(22) Filed: Oct. 8, 2025

(30) Foreign Application Priority Data
Mar. 31, 2025 (IN) 202511031677

(51) Int. Cl. H04L 61/4511; H04L 45/745

(52) U.S. Cl. CPC H04L 61/4511; H04L 45/745

(57) ABSTRACT

Systems and methods for processing a request from a client computing device to communicate with a computer network resource comprise receiving a domain name system (DNS) request from the client computing device directed to a first DNS server; redirecting the DNS request to a second DNS server determining whether the DNS request complies with a predetermined policy; outputting, from the second DNS server to the network device, an internet protocol (IP) address in response to the DNS request complying with the predetermined policy; configuring an IP table ruleset stored at the network device to include the IP address; and controlling a data output from the client computing device directed to the computer network resource based on a determination that the IP address is in the IP table ruleset.

### RELATED APPLICATION

This application claims priority to India Provisional Patent Application No. 202511031677, filed on Mar. 31, 2025 and titled “Domain Name System Filtering at Edge Network Device” the entirety of which is incorporated by reference herein.

### FIELD

The present disclosure relates generally to computer network security. More specifically, the present disclosure describes network devices that enforce traffic routing and controlled website access by client computing devices.

### BACKGROUND

A Domain Name System (DNS) is a known Internet feature that translates domain names to Internet Protocol (IP) addresses required for identifying devices on a computer network, and maps the IP addresses to host computers connected to the network via a resolution process.

DNS services are common targets for malicious cyberattacks such as ransomware, malware, phishing, and the like. For example, DNS hijacking is a type of attack that enables a malicious third party to take over the DNS settings and reroute users to fraudulent websites. In edge computing environments, DNS resolution is performed at locations physically closer to users. However, DNS at the edge can be particularly vulnerable to malicious activities, for example, poisoning the DNS cache at the network edge, causing users to be redirected to malicious websites.

### SUMMARY

In brief overview, this disclosure provides for a secure system and method that rely on edge network devices such as access points and switches to enforce traffic routing through an administrator's preferred DNS server. This feature ensures that users cannot override DNS settings on their devices, while also preventing client access to blocked and malicious websites, including those clients such as endpoints, mobile devices, or the like that connect to networks using edge devices.

### BRIEF DESCRIPTION OF THE DRAWINGS

The above and further advantages of the foregoing may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the disclosed concepts and features.

FIG. 1 depicts a block diagram of a threat management facility, in accordance with an example embodiment.

FIG. 2 depicts a block diagram of selected components of a computing environment that provides domain name service (DNS) protection, in accordance with an example embodiment.

FIG. 3 depicts a flow diagram of a method for DNS filtering, in accordance with an example embodiment.

FIG. 4 depicts a diagram of a client accessing a non-malicious site, in accordance with an example embodiment.

FIG. 5 depicts a diagram of a client attempting to access a malicious site, in accordance with an example embodiment.

FIG. 6 depicts a diagram of a client attempting to access a malicious site, in accordance with another example embodiment.

FIG. 7 depicts a sequence diagram of a DNS query resolution flow, in accordance with an example embodiment.

FIG. 8 depicts a diagram of an example computing device, according to an example embodiment.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The disclosed concepts and features are described in more detail with reference to exemplary embodiments thereof as shown in the accompanying drawings. While the various concepts and features are described in conjunction with various embodiments and examples, it is not intended that the concepts and features are limited to such embodiments. On the contrary, the various concepts and features encompasses various alternatives, modifications and equivalents, as will be appreciated by those of skill in the art. Those of ordinary skill having access to the concepts described herein will recognize additional implementations, modifications and embodiments, as well as other fields of use, which are within the scope of the present disclosure as described herein.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

It should also be understood that endpoints, devices, compute instances or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location in a network environment unless a different meaning is explicitly provided or otherwise clear from the context.

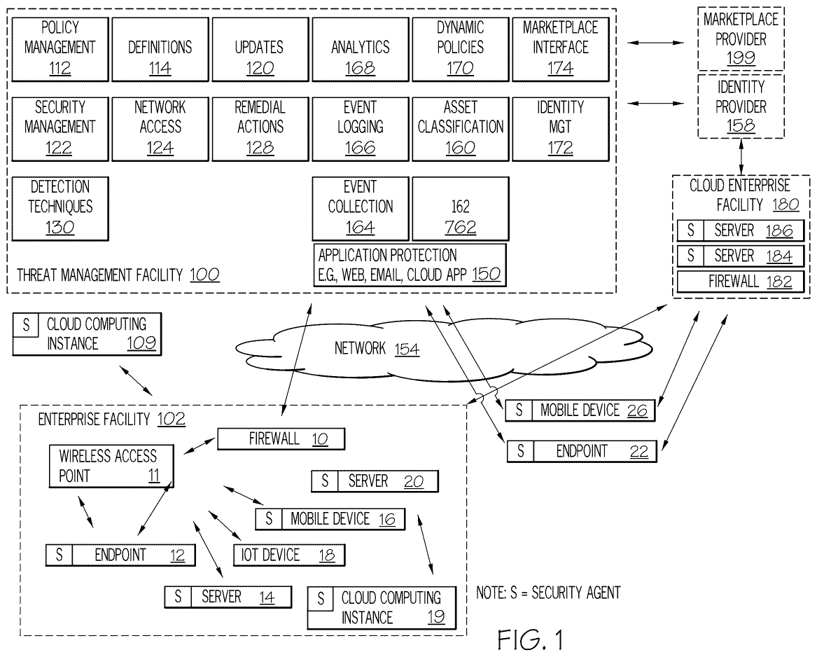

FIG. 1 depicts a block diagram of a threat management facility 100 providing protection against a plurality of threats, such as malware, viruses, spyware, cryptoware, adware, Trojans, spam, intrusion, policy abuse, improper configuration, vulnerabilities, improper access, uncontrolled access, code injection attacks and more according to an example embodiment. The threat management facility 100 may be used for performing DNS resolution in the manner described herein.

The threat management facility 100 may communicate with, coordinate, and control operation of security functionality at different control points, layers, and levels within the facility 100. A number of capabilities may be provided by the threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats or unwanted activity. In embodiments, the threat management facility 100 may provide protection from a variety of threats or unwanted activity to an enterprise facility that may include a variety of compute instances in a variety of locations and network configurations.

Just as one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management facility 100, an exemplary enterprise facility 102 may be or may include any networked computer-based infrastructure. For example, the enterprise facility 102 may be corporate, commercial, organizational, educational, governmental, or the like. As home networks get more complicated and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is merely exemplary, and it will be understood that there may be any number of compute instances, less or more of each type of compute instance, and other types of compute instances. As shown, the exemplary enterprise facility includes a firewall 10, a wireless access point 11, an endpoint 12, a server 14, a mobile device 16, an appliance or IOT device 18, a cloud computing instance 19, and a server 20. Again, the compute instances 10-20 depicted are exemplary, and there may be any number or type of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include certain facilities, such as a policy management facility 112, security management facility 122, update facility 120, definitions facility 114, network access rules facility 124, remedial action facility 128, detection techniques facility 130, application protection facility 150, asset classification facility 160, entity model facility 162, event collection facility 164, event logging facility 166, analytics facility 168, dynamic policies facility 170, identity management facility 112, and marketplace management facility 174, as well as other facilities. For example, there may be a testing facility, a threat research facility, and other facilities. It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility. Some or all of one or more of the facilities 100, 112-174 may be provided on the same physical hardware or logical resource as a gateway, such as a firewall 10, or wireless access point 11. Some or all of one or more of the facilities may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider may communicate with the threat management facility 100 via the marketplace interface facility 774 to provide additional functionality or capabilities to the threat management facility 100 and compute instances 10-26. A marketplace provider 199 may be selected from a number of providers in a marketplace of providers that are available for integration or collaboration via the marketplace interface facility 774. A given marketplace provider 199 may use the marketplace interface facility 174 even if not engaged or enabled from or in a marketplace. As non-limiting examples, the marketplace provider 199 may be a third-party information provider, such as a physical security event provider; the marketplace provider 199 may be a system provider, such as a human resources system provider or a fraud detection system provider; the marketplace provider 199 may be a specialized analytics provider; and so on. The marketplace provider 199, with appropriate permissions and authorization, may receive and send events, observations, inferences, controls, convictions, policy violations, or other information to the threat management facility. For example, the marketplace provider 199 may subscribe to and receive certain events, and in response, based on the received events and other events available to the marketplace provider 199, send inferences to the marketplace interface, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider.

In embodiments, the identity provider 158 may provide user identity information, such as multi-factor authentication, to a SaaS application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22, 26 use a network that is outside of the enterprise facility 102 and separated from the enterprise facility 102, e.g., by a gateway, a public network, and so forth.

In some implementations, compute instances 10-26 may communicate with a cloud enterprise facility 780. The cloud enterprise facility may include one or more cloud applications, such as a SaaS application, which is used by but not operated by the enterprise facility 102. Exemplary commercially available SaaS applications include Salesforce, Amazon Web Services (AWS) applications, Google Apps applications, Microsoft Office 365 applications and so on. A given SaaS application may communicate with an identity provider 158 to verify user identity consistent with the requirements of the enterprise facility 102. The compute instances 10-26 may communicate with an unprotected server (not shown) such as a web site or a third-party application through an internetwork 154 such as the Internet or any other public network, private network or combination of these.

The cloud enterprise facility 180 may include servers 184, 186, and a firewall 182. The servers 184, 186 on the cloud enterprise facility 180 may run one or more enterprise or cloud applications, such as SaaS applications, and make them available to the enterprise facilities 102 compute instances 10-26. It should be understood that there may be any number of servers 184, 186 and firewalls 182, as well as other compute instances in a given cloud enterprise facility 180. It also should be understood that a given enterprise facility may use both SaaS applications and cloud enterprise facilities 180, or, for example, a SaaS application may be deployed on a cloud enterprise facility 180.

In embodiments, aspects of the threat management facility 100 may be provided as a stand-alone solution. In other embodiments, aspects of the threat management facility 100 may be integrated into a third-party product. An application programming interface (e.g., a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to directly. Alternatively, the threat management facility may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in the security agent of an endpoint 12, in a wireless access point 11 or firewall 10, as part of application protection 150 provided by the cloud, and so on.

In an embodiment, the security management facility 122 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an embodiment, security management facility 122 may provide for web security and control, for example, to detect or block viruses, spyware, malware, unwanted applications, help control web browsing, and the like, which may provide comprehensive web access control enabling safe, productive web browsing. Web security and control may provide Internet use policies, reporting on suspect compute instances, security and content filtering, active monitoring of network traffic, URI filtering, and the like. Aspects of the web security and control may be provided, for example, in the security agent of an endpoint 12, in a wireless access point 11 or firewall 10, as part of application protection 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In embodiments, some reputation information may be stored on a compute instance 10-26, and other reputation data available through cloud lookups to an application protection lookup database, such as may be provided by application protection 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the prevention of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update management facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Exemplary rules include access permissions associated with networks, applications, compute instances, users, content, data, and the like. The policy management facility 112 may use a database, a text file, other data store, or a combination to store policies. In an embodiment, a policy database may include a block list, a blacklist, an allowed list, a whitelist, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. Exemplary policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of USB disks, and policy management 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access to data and network resources may be restricted when they are installed and running. In the case where such applications are services which are provided indirectly through a third-party product, the applicable application or processes may be suspended until action is taken to remove or disable the third-party product.

The policy management facility 112 may also require update management (e.g., as provided by the update facility 120). Update management for the security facility 122 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security facility 122 and policy management facility 112 may push information to the enterprise facility 102 network and/or the compute instances 10-26, the enterprise facility 102 network and/or compute instances 10-26 may pull information from the security facility 122 and policy management facility 112, or there may be a combination of pushing and pulling of information. For example, the enterprise facility 102 network and/or compute instances 10-26 may pull update information from the security facility 122 and policy management facility 112 via the update facility 120, an update request may be based on a time period, by a certain time, by a date, on demand, or the like. In another example, the security facility 122 and policy management facility 112 may push the information to the enterprise facility's 102 network and/or compute instances 10-26 by providing notification that there are updates available for download and/or transmitting the information. In an embodiment, the policy management facility 112 and the security facility 122 may work in concert with the update management facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a block list, a blacklist, an allowed list, a whitelist, an unacceptable network site database, an acceptable network site database, a network site reputation database, or the like of network access locations that may or may not be accessed by the client facility. Additionally, the network access facility 124 may use rule evaluation to parse network access requests and apply policies. The network access rule facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, MacOS, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility may include entity models 162. The entity models may be used, for example, to determine the events that are generated by assets. For example, some operating systems may provide useful information for detecting or identifying events. For example, operating systems may provide process and usage information that is accessed through an API. As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection facility 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. An exemplary event may be communication of a specific packet over the network. Another exemplary event may be the identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility. Observations or inferences about events may also be logged by the event logging facility 166.

When a threat or other policy violation is detected by the security management facility 122, the remedial action facility 128 may be used to remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 122 may take any steps or deploy any measures suitable for addressing a detection of a threat, potential threat, policy violation or other event, code or activity that might compromise security of a computing instance 10-26 or the enterprise facility 102.

While the above description of the threat management facility 100 describes various threats typically coming from a source outside the enterprise facility 102, it should be understood that the disclosed embodiments contemplate that threats may occur to the enterprise facility 102 by the direct actions, either intentional or unintentional, of a user or employee associated with the enterprise facility 102. Thus, reference to threats hereinabove may also refer to instances where a user or employee, either knowingly or unknowingly, performs data exfiltration from the enterprise facility 102 in a manner that the enterprise facility 102 wishes to prevent.

Embodiments of the present invention contemplate a DNS architecture that blocks users with client computing devices, for example, endpoints 12 in FIG. 1, behind edge network devices, e.g., firewalls, network switches, routers, access points, and the like, such as a wireless access point 11 in FIG. 1, from accessing desired computer network resources having domains that do not comply with a policy configuration, for example, a corporate policy shown and further described herein below. When a user enters a desired Uniform Resource Locator (URL), or address of a unique resource on the internet into a browser or other input of the client, the client outputs a DNS request to an edge network device, referred to generally as a network device, which in turn communicates the DNS request with a special-purpose, or trusted, DNS server, also referred to as a secure and reputable DNS server. Even if the DNS request is intended to be sent by the client to a particular DNS server of interest, in all cases the DNS request is redirected or forwarded to the trusted DNS server, which receives and processes the DNS request regardless of the client's specification of a different DNS server.

In addition, in cases where a user attempts to circumvent a trusted DNS server and enter a specific IP address, the request is intercepted by the network device and dropped if the IP address is not found in a rules table module of the network device populated with legitimate IP addresses affirmed, e.g., determined to be reputable, according to predetermined rules. In some embodiments, the rules table module stores IP addresses provided by a DNS resolver, and more specifically, adds and maps the IP addresses, e.g., determined to be reputable by the trusted DNS server, to a set of predetermined rules establishing whether traffic can be directed to an IP address. The reputable IP address can be provided to the rules table module in response to a DNS request resolving a domain name to an IP address. The network device can store the IP addresses at the rules table module according to a predetermined set of programmed rules to control data communications from the client device to the desired destination provided in the DNS request. In doing so, the network device can block traffic to IP addresses that have not be resolved by a DNS query and stored at a local cache.

The edge network device intercepting client requests in this manner ensures secure and reliable DNS resolution for the edge network device by preventing authorized changes and enhancing network security. This can be achieved at least in part by a domain categorizer backend system, which can determine and/or identify a predetermined category of the domain identified in the DNS request. More specifically, domain categories can be determined for a website associated with the incoming DNS request, e.g., a “news” category associated with “www.nytimes.com.” In some embodiments, a backend system may include a policy database that determines whether the requested domain is authorized according to a predetermined policy, and whether the request should be subjected to additional inspection. The policy database may store policy configuration data that protects customers from accessing domains that do not comply with a predetermined policy, such as a corporate policy. More specifically, policies may be evaluated based on a category associated with a website corresponding to an IP address, where the website is requested by an endpoint in communication with the trusted DNS server via the edge network device.

A feature of the DNS architecture according to some embodiments includes support for the bypassing of a private DNS domain using custom DNS routing. To bypass a private DNS domain, a DNS server is configured that doesn't enforce the restrictions or settings of a private DNS service. Typically, this is implemented if one is trying to access a domain or service that is being filtered or blocked by a private DNS system. However, the DNS architecture does not permit DNS requests to circumvent the trusted DNS server.

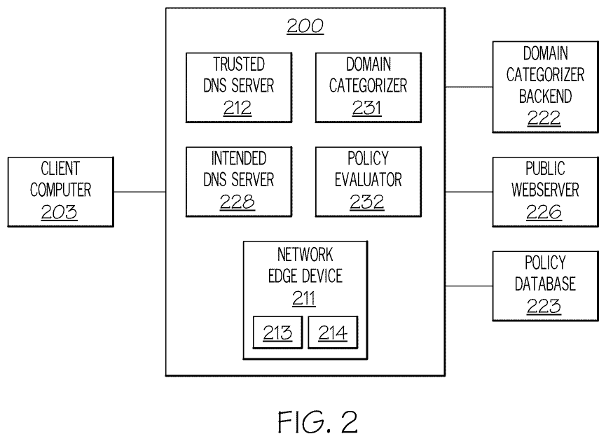

Referring now more specifically to the architecture and sequence flows embodied by the present concepts. At a high level, as shown in FIG. 2, a DNS architecture 200 may include a network device 211 and a dedicated or trusted DNS server 212. In some embodiments, the DNS architecture 200 may also include a domain categorizer 231 that communicates with a domain categorizer backend and a policy evaluator 232. The computing environment may include other components not shown or described for brevity. In one example, a DNS resolver is not shown but can nevertheless by part of the trusted DNS server 212 for processing DNS requests. In another example, a Dynamic DNS (DDNS) poller (not shown) may communicate with the DNS server 212 to automatically update DNS records when an IP address changes. This computing environment is constructed and arranged to control client access to websites or other computer network resource configured to exchange data with a client computing device 203. In this example, the DDNS poller can be used with client computing devices 203 that have an Internet connection with a dynamic IP address.

The network device 211 is configured to manage traffic between the client devices 203 and a network, for example, other client devices, servers, and so on. To facilitate a data communication, the network device 211 receive and process DNS requests from one or more client computing devices 203 and operates as an intermediary between the client computing devices 203 and the trusted DNS server 212. In some embodiments, the network device 211 includes an access point, for example, for wireless client computers such as smartphones or the like. In other embodiments, the network device 211 includes a network switch, for example, a switch edge device such as a router, switch, firewall, integrated access device (IAD), wireless access point, edge server, and so on. The network device 211 manages traffic by including a rules table module 213 for blocking traffic to IP addresses not resolved by DNS queries. In particular, the rules table module 213 can be programmed with rules that allow packets to be output from the client computing device 203 to a destination IP address that is stored at the rules table module 213, or conversely, to prevent packets from being output from the network device 211 in the absence of a destination IP address at the rules table module 213. The determination of whether a destination IP address is stored at the rules table module 213 depends on the trusted DNS server 212 establishing that the IP address is reputable, e.g., after communicating with the domain categorizer backend 222 and providing the IP address to the network device 211 and the network device 211 adding the IP address to the set of rules.

A feature of the network device 211 is to send all DNS requests to the trusted DNS server 212 even if another DNS server 228 is the intended recipient of the DNS request. For example, a DHCP server (not shown) may automatically assign a DNS server address in response to a DNS request or a fixed, or static, IP address may be assigned so that DNS requests are directed to be sent to an original DNS server 228. In these cases where a DNS request is directed to a different DNS server 228, the network device 211 nevertheless redirects or forwards the DNS request to the trusted DNS server 212.

The trusted DNS server 212 receives and processes inbound DNS requests, preferably from known or registered IP addresses but not limited thereto, and allows for the secure processing of the DNS requests. The trusted DNS server 212 processes DNS traffic while authorizing requests through policy evaluation. In some embodiments, the trusted DNS server 212 stores and executes a plurality of plugins, such as an SXL plugin used for categorization and risk score.

The domain categorizer system 213 is constructed and arranged to communicate with a domain categorizer backend system 222 to perform a lookup and retrieve category information for a requested domain. The domain categorizer system 213 may be responsible to extract category and/or reputation details of a domain query of the incoming request. The policy evaluator 232 may be responsible to enforce the access policy applicable to the particular domain category-policy pair. The policy evaluator 232 may communicate with the trusted DNS server 212 to perform a policy evaluation using the retrieved category information, which may permit either an access to the particular domain allowed by policy, or block the domain. The policy evaluator 232 may be operably connected to a policy database 223 or the like, which may have a policy storage, or connected to policy storage separate from the backend system 222 to retrieve and process DNS protection policies, namely, policies used by the DNS server 212 to distinguish malicious sites from non-malicious sites. In some embodiments, policy database 223 may communicate with or be part of the policy management facility 112 of FIG. 1 to include dynamic policies used for security decisions, such as whether the client computing device 203 is permitted to access a website of interest, for example, at the webserver 226.

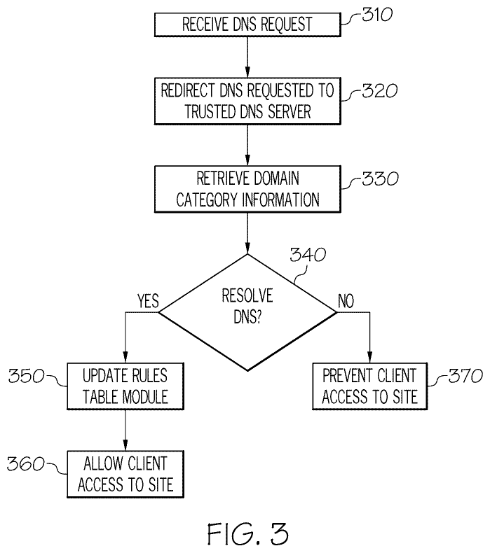

FIG. 3 depicts a method 300 for DNS filtering, in accordance with an example embodiment. The method 300 may be performed at the computing environment 100 and DNS architecture 200 of FIGS. 1 and 2, respectively.

At step 310, a DNS request is received by a network device 211, e.g., switch edge device, access point, or the like. In some embodiments, the DNS request is output to an intended original DNS server via DHCP. In other embodiments, the client 203 requests an IP address via a manual configuration.

At step 320, the DNS request is directed by the network device 211 to the trusted DNS server 212 regardless of whether the DNS request indicates a different, or original intended, DNS server.

At step 330, the trusted DNS server 212 communicates with the domain categorizer backend system 222 to retrieve the category information for the requested domain, which can be used to determine whether the client computing device 203 is authorized to access the domain of the intended computer network resource, e.g., webserver 222 shown in FIG. 2. In some embodiments, the policy configuration in step 330 may determine whether the DNS server 212 detects the webserver 222 as being either a malicious website or a non-malicious website.

At decision diamond 340, the DNS server 212 determines whether to resolve the DNS based on the policy configuration in step 330, If yes, at step 350, a determination is made that the edge device receives a DNS response and the DNS server 212 sends an IP address to the network device 211. The edge device can create a rule allowing for the requested connection, for example, by updating the rules table module 213 to include the IP address. If the policy configuration that the site, e.g., webserver 222, is not malicious and complies with a predetermined policy, then at step 350, the DNS server 212 sends an IP address to the network device 211 for updating the rules table module 213 so that future attempts by the computing device 203 to use the IP address can be made directly to the network device 211. At step 360, a DNS response is forwarded to the client 203 so that the client 203 can access the site.

If at decision diamond 340, the policy configuration determines that the site is malicious, then the method proceeds to step 370, where the trusted DNS server 212 drops the DNS request so that the client 203 cannot access the website, e.g., at public webserver 226. In dropping the DNS query, the trusted DNS server 212 does not respond to the DNS request so that no DNS response is sent to the client 203, for example, for added security. In other embodiments, In other embodiments, at step 370, instead of a drop, the trusted DNS server 212 sends a DNS response to the client 203, e.g., a NXDOMAIN response, preventing access to the domain or IP address of interest, for example, due to a policy decision made by the domain categorizer backend system 222 so that access to malicious domains, ad sites, or other undesired content is blocked. The abovementioned allow, block and refuse responses may be based on domain categorization and policy evaluation in step 330.

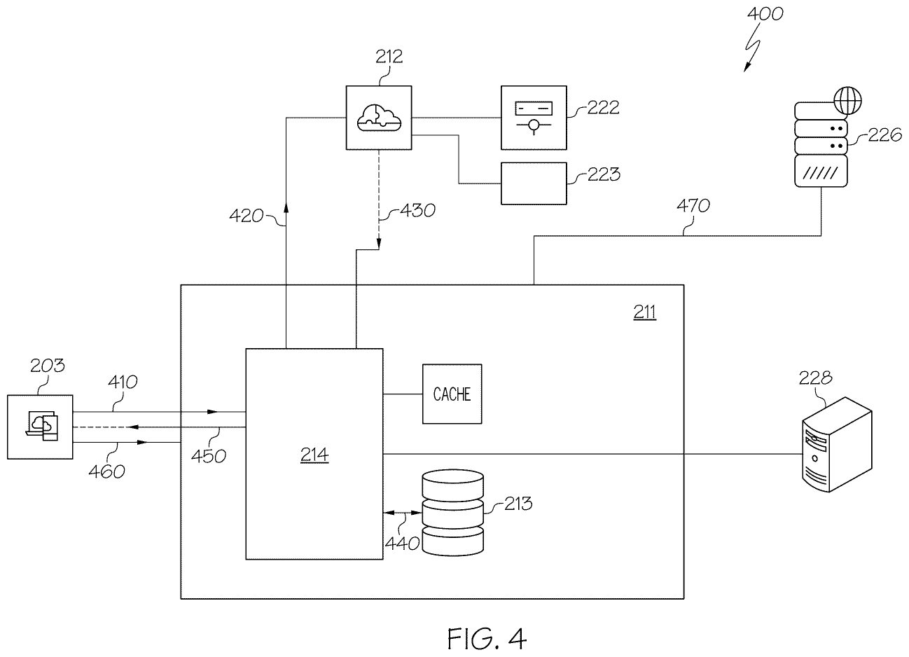

FIG. 4 depicts a sequence diagram 400 of a client accessing a non-malicious site, in accordance with an example embodiment. In describing the sequence diagram 400, reference is made to elements of the DNS architecture 200 of FIG. 2.

During operation, the client 203 sends (410) a DNS request for accessing the site 226 to a DNS server. The network device 211 has a DNS forwarder module 214 that redirects or forwards (420) the DNS request to the trusted DNS server 212. Based on the policy configuration, the trusted DNS server 212 determines (430) that the site 226 is a non-malicious site and resolves it to a valid IP address. The DNS server 212 may also send a DNS response to the network device 211. The network device may monitor the DNS response (430) and configure (440) the IP table ruleset 213 stored at the network device 211 to include the IP address. The network device 211 forwards (450) the DNS response to the client computing device 203.

Based on the DNS response, the client computing device 203 sends (460) a request for the IP address. The request may be in any format, for example, an HTTP/HTTPS request but not limited thereto. The network device 211 then allows (470) the traffic to the destination, e.g., webserver 226, due to the IP address in the rules table module 213.

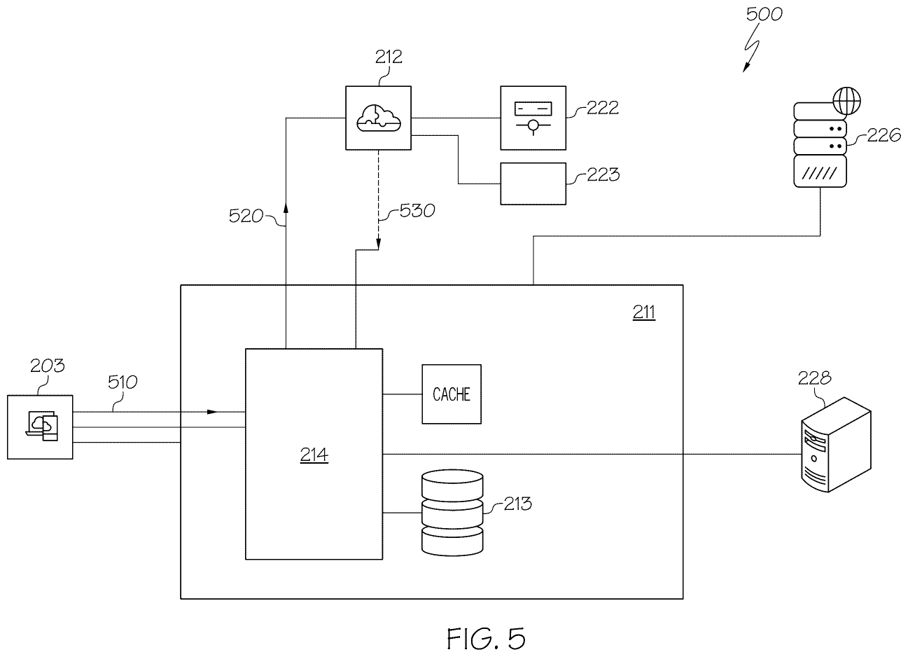

FIG. 5 depicts a sequence diagram 500 of a client attempting to access a malicious site, in accordance with an example embodiment. In describing the sequence diagram 500, reference is made to elements of the DNS architecture 200 of FIG. 2.

During operation, the client 203 sends (510) a DNS request for accessing the site 226 to a DNS server. The network device 211 redirects or forwards (520) the DNS request to the trusted DNS server 212. Based on the policy configuration, the trusted DNS server 212 determines that the site 226 is a malicious site and drops (530) the DNS request so that the client 203 cannot access the site of interest 226.

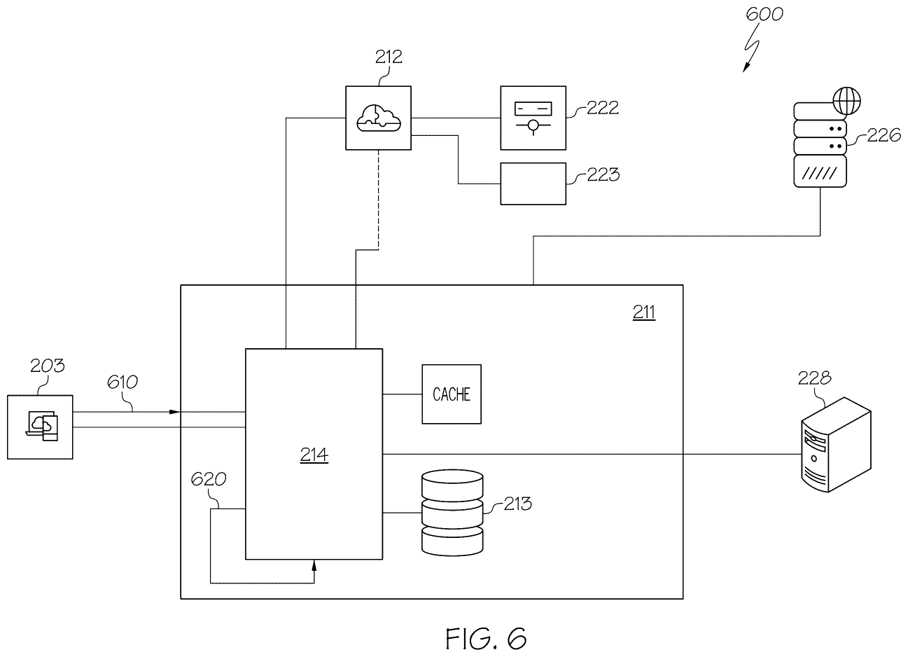

FIG. 6 depicts a sequence diagram 600 of a client attempting to access a non-malicious site, in accordance with another example embodiment. In describing the sequence diagram 600, reference is made to elements of the DNS architecture 200 of FIG. 2.

An advance attacker sends (610) a HTTP request directly to the network switch 211, e.g., bypassing a DNS request, using a local host entry. For example, an attacker may modify the host file on the client computing device 203 to redirect traffic intended for legitimate sites to a malicious server. However, the network device 211 drops (620) this request because there is no rule in the rules table module 213 that allows traffic to the IP address requested by the attacker.

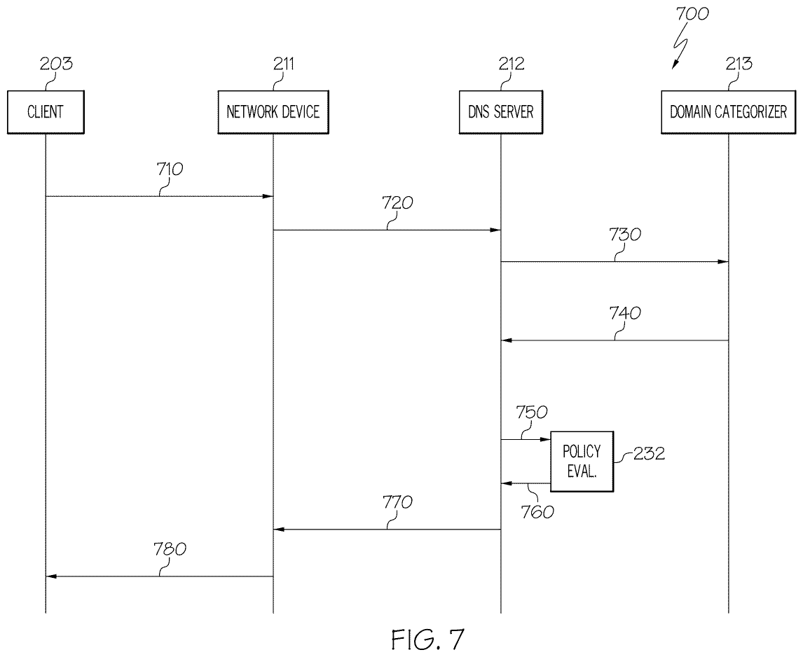

FIG. 7 depicts a sequence diagram 700 of a DNS query resolution flow, in accordance with an example embodiment. In describing the sequence diagram 700, reference is made to elements of FIG. 2. On receiving (710) the inbound DNS request from a client computing device 203, actions may be performed by the network device 211, trusted DNS server 212, domain categorizer 213, and policy evaluator 232 of the DNS architecture 200 of FIG. 2. In particular, the incoming request can be processed by the network device 211, which forwards (720) the DNS request to the trusted DNS server 212 regardless of whether the DNS request includes a different DNS server.

The next step is to retrieve (730) the category information for the requested domain. The domain category is first looked up in the domain categorizer 213, and only if the domain category is not available locally then a long poll request is submitted to the backend 222. Once the category information is received from backend 222 it will be cached locally so that the subsequent requests for the same domain will be faster. The category response (740) is sent to the trusted DNS server 212.

Next, the trusted DNS server 212 may request (750) the policy evaluator 232 to perform a policy evaluation using the category information and attached to the source IP. Evaluation of the relevant policy for an incoming DNS request represents a core added value of the DNS architecture 200. The policy evaluation may be executed by the policy evaluator 232 upon a request (750) from the DNS server 212. If the access to the particular domain is allowed by policy, the DNS record information may be returned in a policy evaluation result (760). Otherwise, the domain may be blocked.

In response to the policy evaluation result (760), a final decision is sent to the network device 211 in the DNS response (770) whether to allow or block the inbound DNS request. The network device 211 can store the IP address provided by a DNS resolver of the DNS server 212 or other DNS-generating device, and more specifically, the network device 211 may add to the table 213 the IP address determined to be reputable by the trusted DNS server 212 to a set of predetermined rules. Next, the network device 211 can send (780) a response to the client 203, more specifically, either an ‘allow’ or ‘reject’ response, which may include a block, refuse, drop, or the like described above.

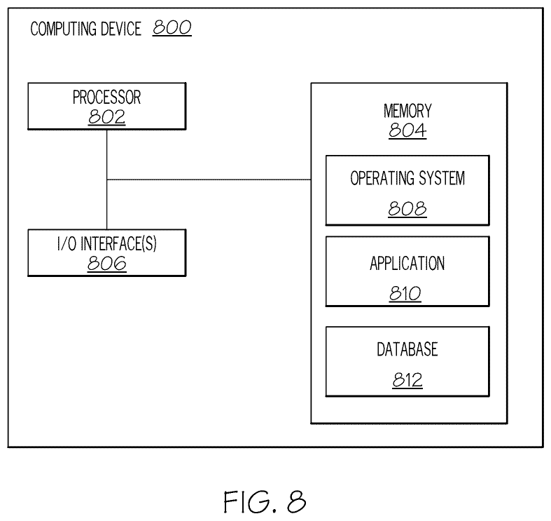

FIG. 8 is a diagram of an example computing device 800, according to an example embodiment. As shown, the computing device 800 includes one or more processors 802, non-transitory computer readable medium or memory 804, I/O interface devices 806 (e.g., wireless communications, etc.) and a network interface 808. The computer readable medium 804 may include an operating system 808, a database, or data section 812, and an application 810 for controlling access to a destination computer network resources such as a website based on a dedicated DNS server's response to a DNS request, in accordance with the systems and methods described herein.

In operation, the processor 802 may execute the application 810 stored in the computer readable medium 804. The application 810 may include software instructions that, when executed by the processor, cause the processor to perform operations for performing operations according to the systems and methods described and shown in FIG. 2-7. With particular regard to FIG. 2, the application 810 may store computer code of the DNS server 212, domain categorizer 231, and/or policy evaluator 232.

The application program 810 may operate in conjunction with the data section 812 and the operating system 808. The device 800 may communicate with other devices (e.g., a wireless access point) via the I/O interfaces 806.

It will be appreciated that the modules, processes, systems, and sections described above may be implemented in hardware, hardware programmed by software, software instructions stored on a non-transitory computer readable medium or a combination of the above. A system as described above, for example, may include a processor configured to execute a sequence of programmed instructions stored on a non-transitory computer readable medium. For example, the processor may include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions may be compiled from source code instructions provided in accordance with a programming language such as Java, C, C++, C#.net, assembly or the like. The instructions may also comprise code and data objects provided in accordance with, for example, the Visual Basic™ language, or another structured or object-oriented programming language. The sequence of programmed instructions, or programmable logic device configuration software, and data associated therewith may be stored in a non-transitory computer-readable medium such as a computer memory or storage device which may be any suitable memory apparatus, such as, but not limited to ROM, PROM, EEPROM, RAM, flash memory, disk drive and the like.

Furthermore, the modules, processes, systems, and sections may be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above may be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules) may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein may be used to implement embodiments of the method, system, or a computer program product (software program stored on a non-transitory computer readable medium).

Furthermore, embodiments of the disclosed method, system, and computer program product (or software instructions stored on a non-transitory computer readable medium) may be readily implemented, fully or partially, in software using, for example, object or object-oriented software development environments that provide portable source code that may be used on a variety of computer platforms. Alternatively, embodiments of the disclosed method, system, and computer program product may be implemented partially or fully in hardware using, for example, standard logic circuits or a VLSI design. Other hardware or software may be used to implement embodiments depending on the speed and/or efficiency requirements of the systems, the particular function, and/or particular software or hardware system, microprocessor, or microcomputer being utilized. Embodiments of the method, system, and computer program product may be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) may be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media for performing DNS resolution.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter. It should also be understood that references to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

1. A method for processing a request from a client computing device to communicate with a computer network resource, comprising:
receiving, by a network device, a domain name system (DNS) request from the client computing device directed to a first DNS server;
redirecting, by the network device, the DNS request to a second DNS server;
determining whether the DNS request complies with a predetermined policy;
outputting, from the second DNS server to the network device, an internet protocol (IP) address in response to the DNS request complying with the predetermined policy;
configuring an IP table ruleset stored at the network device to include the IP address; and
controlling a data output from the client computing device directed to the computer network resource based on a determination that the IP address is in the IP table ruleset.

2. The method of claim 1, further comprising:
dropping, by the second DNS server, the DNS request based on the DNS request failing to comply with the predetermined policy.

3. The method of claim 1, wherein controlling the data output from the client computing device comprises blocking the data output based on determining that the IP address is not in the IP table ruleset.

4. The method of claim 1, wherein determining whether the DNS request complies with a predetermined policy, comprises:
outputting the DNS request from the second DNS server to a domain categorization system to determine a domain category and a risk score of the computer network resource; and
performing a policy evaluation operation using the domain category and risk score to determine if access to the computer network resource is permitted by the client computing device according to the predetermined policy.

5. The method of claim 4, wherein the predetermined policy includes a policy action, the policy action including at least one of an allowance of the DNS request and generating of the DNS response, a refusal of the DNS request sent with the DNS response to the client computing device, a blocking of access to a domain sent with the DNS response to the client computing device, and a dropping of the DNS request so that no DNS response is sent to the client computing device.

6. The method of claim 1, wherein the computer network resource includes a web server or an email server.

7. The method of claim 1, further comprising:
forwarding a DNS response from the network device to the client computing device including the IP address;
outputting, by the client computing device, a Hypertext Transfer Protocol (HTTP) request to the IP address;
transmitting the data output from the client computing device to the computer network resource.

8. A method for processing a request from a client computing device to communicate with a computer network resource, comprising:
receiving, by a network device that controls an output of data to a network to which the client computing device and the computer network resource are connected, a domain name system (DNS) request from the client computing device directed to a first DNS server;
redirecting, by the network device, the DNS request to a second DNS server;
determining whether the DNS request complies with a predetermined policy;
receiving, by the access point from the second DNS server, a policy action that determines whether to configure an IP table ruleset stored at the network device to include an IP address in response to the DNS request; and
controlling a data output by the client computing device to the computer network resource based on a determination whether the IP address is in the IP table ruleset.

9. The method of claim 8, further comprising:
dropping, by the second DNS server, the DNS request based on the DNS request failing to comply with the predetermined policy.

10. The method of claim 8, wherein controlling the data output from the client computing device comprises blocking the data output based on determining that the IP address is not in the IP table ruleset.

11. The method of claim 8, wherein determining whether the DNS request complies with a predetermined policy to which the policy action is associated comprises:
outputting the DNS request from the second DNS server to a domain categorization system to determine a domain category and a risk score of the computer network resource; and
performing a policy evaluation operation using the domain category and risk score to determine if access to the computer network resource is permitted by the client computing device according to the predetermined policy.

12. The method of claim 8, wherein the policy action includes at least one of an allowance of the DNS request and generating of the DNS response, a refusal of the DNS request sent with the DNS response to the client computing device, a blocking of access to a domain sent with the DNS response to the client computing device, and a dropping of the DNS request so that no DNS response is sent to the client computing device.

13. The method of claim 8, wherein the computer network resource includes a web server or an email server.

14. The method of claim 8, further comprising:
forwarding a DNS response from the network device to the client computing device including the IP address;
outputting, by the client computing device, a Hypertext Transfer Protocol (HTTP) request to the IP address;
transmitting the data output from the client computing device to the computer network resource.

15. A computer system, comprising:
one or more memory devices coupled to the one or more processors storing program code executable by the one or more processors; and
one or more processors that, having executed the program code, configure the computer system to perform a plurality of operations comprising:
receiving a domain name system (DNS) request from a client computing device directed to a first DNS server;
redirecting the DNS request to a second DNS server;
determining whether the DNS request complies with a predetermined policy;
receiving a policy action that determines whether to configure an IP table ruleset to include an IP address in response to the DNS request; and
controlling a data output by the client computing device to the computer network resource based on a determination whether the IP address is in the IP table ruleset.

16. The computer system of claim 15, wherein the plurality of operations further comprise:
dropping, by the second DNS server, the DNS request based on the DNS request failing to comply with the predetermined policy.

17. The computer system of claim 1, wherein controlling the data output from the client computing device comprises blocking the data output based on determining that the IP address is not in the IP table ruleset.

18. The computer system of claim 15, wherein determining whether the DNS request complies with a predetermined policy, comprises:
outputting the DNS request from the second DNS server to a domain categorization system to determine a domain category and a risk score of the computer network resource; and
performing a policy evaluation operation using the domain category and risk score to determine if access to the computer network resource is permitted by the client computing device according to the predetermined policy.

19. The computer system of claim 18, wherein the predetermined policy includes a policy action, the
policy action including at least one of an allowance of the DNS request and generating of the DNS response, a refusal of the DNS request sent with the DNS response to the client computing device, a blocking of access to a domain sent with the DNS response to the client computing device, and a dropping of the DNS request so that no DNS response is sent to the client computing device.

20. The computer system of claim 15, further comprising:
forwarding a DNS response from the network device to the client computing device including the IP address;
outputting, by the client computing device, a Hypertext Transfer Protocol (HTTP) request to the IP address;
transmitting the data output from the client computing device to the computer network resource.
